(19) United States
(12) Patent Application Publication
(10) Pub. No.: US 2025/0153483 A1
(43) Pub. Date: May 15, 2025

(54) INK EJECTION INSPECTING DEVICE, INK EJECTION INSPECTING METHOD, STORAGE MEDIUM, INK EJECTING DEVICE, AND IMAGE FORMING APPARATUS

(71) Applicant: KONICA MINOLTA, INC., Tokyo (JP)

(72) Inventor: Tetsuo UNO, Tokyo (JP)

(73) Assignee: KONICA MINOLTA, INC., Tokyo (JP)

(21) Appl. No.: 18/932,824

(22) Filed: Oct. 31, 2024

(30) Foreign Application Priority Data
Nov. 13, 2023 (JP) 2023-192804

(51) Int. Cl. B41J 2/165; B41J 2/045

(52) U.S. Cl. CPC B41J 2/16579; B41J 2/04563; B41J 2/04581; B41J 2/04588; B41J 2202/08

(57) ABSTRACT

An ink ejection inspecting device that inspects an ejection state of inks from a plurality of nozzles provided in an ink ejecting device includes: a head drive controller that applies an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges; and a state determinator that determines an ink ejection state of each of the nozzles on a basis of residual vibration of each of the nozzles obtained by applying the inspection voltage.

### BACKGROUND OF THE INVENTION

### Technical Field

The present invention relates to an ink ejection inspecting device, an ink ejection inspecting method, a storage medium storing an ink ejection inspecting program, an ink ejecting device, and an image forming apparatus.

### Description of Related Art

An inkjet type image forming apparatus includes an ink ejecting device. The ink ejecting device causes a drive element to drive a piezoelectric element provided in each nozzle, thereby ejecting ink droplets from the nozzle. Such an ink ejecting device can detect an ink ejection state of each nozzle on the basis of residual vibration generated when an inspection signal is applied to each nozzle, and various detection methods have been proposed. For example, in JP 2006-231882A, a detection signal (inspection signal) is output to each nozzle after printing on one recording sheet is completed and before a next sheet is positioned at a predetermined position by conveyance on a conveyance belt, and the quality of the ejection state of each nozzle is determined.

However, residual vibration caused by the application of the drive signal for printing is generated in the nozzle immediately after printing is completed. Therefore, when the inspection signal is applied to the nozzle immediately after the printing is completed, the residual vibration caused by the application of the driving signal is added to the residual vibration generated by the inspection signal. Therefore, it has been difficult to accurately detect the ejection state of the ink.

Furthermore, immediately after printing, a variation occurs in the temperature of the nozzle itself and the temperature of the ink in the vicinity of the nozzle due to the ejection frequency at the time of printing, and if inspection is performed immediately after printing, a variation occurs in the waveform of the residual vibration, making accurate measurement difficult.

### SUMMARY OF THE INVENTION

Therefore, an object of the present invention is to provide an ink ejection inspecting device, an ink ejection inspecting method, and an ink ejection inspecting program capable of accurately detecting an ink ejection state of each nozzle, and is further to provide an ink ejecting device and an image forming apparatus capable of forming an image by ink ejection controlled with high accuracy.

The present invention for achieving such an object provides an ink ejection inspecting device that inspects an ejection state of inks from a plurality of nozzles provided in an ink ejecting device, the ink ejection inspecting device including: a head drive controller that applies an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges; and a state determinator that determines an ink ejection state of each of the nozzles on a basis of residual vibration of each of the nozzles obtained by applying the inspection voltage.

There is provided an ink ejection inspecting method that inspects an ejection state of inks from a plurality of nozzles provided in an ink ejecting device, wherein the hardware processor applies an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges, and the hardware processor determines an ink ejection state of each of the nozzles on a basis of residual vibration of each of the nozzles obtained by applying the inspection voltage.

There is provided a storage medium storing an ink ejection inspecting program causing a computer to perform an inspection of an ejection state of inks from a plurality of nozzles provided in an ink ejecting device, the inspection including: applying an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges; and determining an ink ejection state of each of the nozzles on a basis of residual vibration of each of the nozzles obtained by applying the inspection voltage.

There is provided an ink ejecting device including: an ink head provided with a plurality of nozzles that eject an ink by application of a voltage; and the ink ejection inspecting device.

There is provided an image forming apparatus including: the ink ejecting device; and a medium conveyance device that conveys a recording medium on which an image is formed with inks ejected from the plurality of nozzles in the ink ejecting device in a predetermined conveyance direction relative to the ink ejecting device.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a configuration diagram of an image forming apparatus according to a first embodiment;

FIG. 2 is a bottom view of each head unit included in an ink ejecting device included in the image forming apparatus according to the first embodiment;

FIG. 3 is a diagram for illustrating a configuration of the ink ejecting device included in the image forming apparatus according to the first embodiment;

FIG. 4 is a block diagram of essential parts of the image forming apparatus according to the first embodiment;

FIG. 5 is a flowchart illustrating an ink ejection inspecting method according to the first embodiment;

FIG. 6 is a diagram (No. 1) illustrating a standby period of the ink ejection inspecting method according to the first embodiment;

FIG. 7 is a diagram (No. 2) illustrating the standby period of the ink ejection inspecting method according to the first embodiment;

FIG. 8 is a diagram illustrating image formation including the ink ejection inspecting method according to the embodiment;

FIG. 9 is a block diagram of essential parts of the image forming apparatus according to a second embodiment;

FIG. 10 is a diagram (No. 1) illustrating a standby period of the ink ejection inspecting method according to the second embodiment; and

FIG. 11 is a diagram (No. 2) illustrating the standby period of the ink ejection inspecting method according to the second embodiment.

### DETAILED DESCRIPTION

Hereinafter, one or more embodiments of the present invention will be described with reference to the drawings. However, the scope of the invention is not limited to the disclosed embodiments.

Hereinafter, embodiments of an ink ejection inspecting device, an ink ejection inspecting method, an ink ejection inspecting program, an ink ejecting device, and an image forming apparatus to which the present invention is applied will be described in detail with reference to the accompanying drawings. Note that common constituent elements in the embodiments are assigned the same reference numerals, and repetitive descriptions thereof will be omitted.

### First Embodiment

### <<Image Forming Apparatus>>

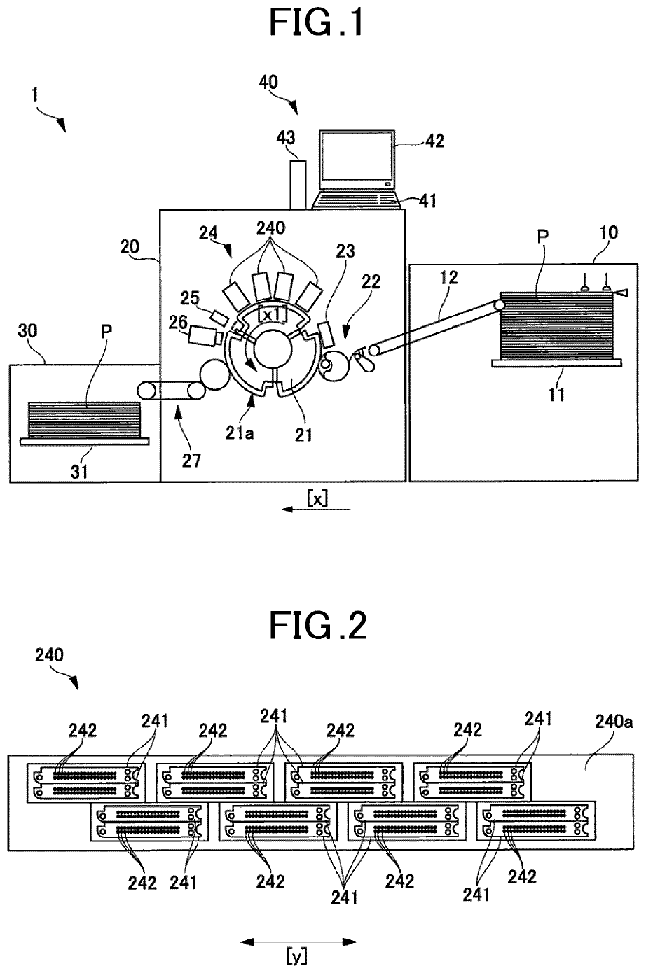

FIG. 1 is a configuration diagram of an image forming apparatus 1 according to a first embodiment. The image forming apparatus 1 illustrated in FIG. 1 is of an inkjet type, includes a medium supplier 10, an image former 20 having an ink ejecting device 24, a medium ejector 30, and a control device 40, and forms an image on a recording medium P. As the recording medium P, in addition to paper such as a plain paper or a coated paper, various media can be used on which ink having landed on the sheet-like main surface can be fixed, such as fabric or sheet-like resin. The configuration of each component of such an image forming apparatus 1 will be described below.

### <Medium Supplier 10>

The medium supplier 10 includes a sheet feed tray 11 that stores the recording medium P, and a supplier 12 that conveys the recording medium P from the sheet feed tray 11 to the image former 20. Note that the recording medium P conveyed from the sheet feed tray 11 to the image former 20 is further conveyed from the image former 20 to the medium ejector 30. Therefore, here, the following description will be given assuming that the arrangement direction of the medium supplier 10, the image former 20, and the medium ejector 30 is a conveyance direction [x] of the recording medium P.

### <Image Former 20>

The image former 20 includes a medium conveyance device 21, a handover unit 22, a heater 23, the ink ejecting device 24, a curing light emitting device 25, an image reading device 26, and a deliverer 27. These configurations are as follows.

### [Medium Conveyance Device 21]

The medium conveyance device 21 is a conveyance drum having a cylindrical shape, and its side circumferential surface is a conveyance surface 21a that attracts and holds the recording medium P. The medium conveyance device 21 holds the recording medium P on the conveyance surface 21a and rotates in one rotation direction [x1] (counterclockwise direction in FIG. 1) around a central axis of a cylindrical shape as a rotation axis. As a result, the medium conveyance device 21 functions as a medium conveyor that conveys the recording medium P attracted and held on the conveyance surface 21a in the rotation direction [x1] on a path along the conveyance surface 21a.

### [Handover Unit 22]

The delivery unit 22 holds and picks up one end of the recording medium P conveyed from the supplier 12 of the medium supplier 10, and hands over the recording medium P to the conveyance surface 21a of the medium conveyance device 21.

### [Heater 23]

The heater 23 is provided on the downstream side of the handover unit 22 in the conveyance direction [x] of the recording medium P and the rotation direction [x1] of the medium conveyance device 21, and heats the recording medium P so that the recording medium P conveyed by the medium conveyance device 21 has a temperature within a predetermined range.

### [Ink Ejecting Device 24]

The ink ejecting device 24 includes a plurality of head units 240 provided on the downstream side of the heater 23 in the conveyance direction [x] of the recording medium P and the rotation direction [x1] of the medium conveyance device 21. The image forming apparatus 1 according to the present embodiment is of a single-pass type in which the plurality of head units 240 are arranged in order from the upstream side in the conveyance direction [x] of the recording medium P, as an example.

FIG. 2 is a bottom view of each of the head units 240 included in the ink ejecting device included in the image forming apparatus according to the first embodiment, and is a diagram illustrating one of the head units 240 illustrated in FIG. 1 as viewed from the conveyance surface 21a side of the medium conveyance device 21. The head unit 240 illustrated in FIGS. 1 and 2 includes a plurality of ink heads 241 arranged along an ink ejection face 240a facing the conveyance surface 21a (see FIG. 1) of the medium conveyance device 21. In the example illustrated, two ink heads 241 constitute one set, and a plurality of sets (eight sets in this example) of ink heads 241 are arranged in two rows in a staggered manner. In each ink head 241, ink ejection openings of the respective nozzles 242 are arranged in a surface positioned at an ink ejection face 240a of the head unit 240.

Each nozzle 242 has an ink chamber for storing ink and an ejection opening for ejecting ink. Of these, the ink chamber has a structure in which a head chip is arranged on a bottom surface. As the head chip, a piezo-type head chip using a piezoelectric element as a driving source for ejecting ink droplets is used.

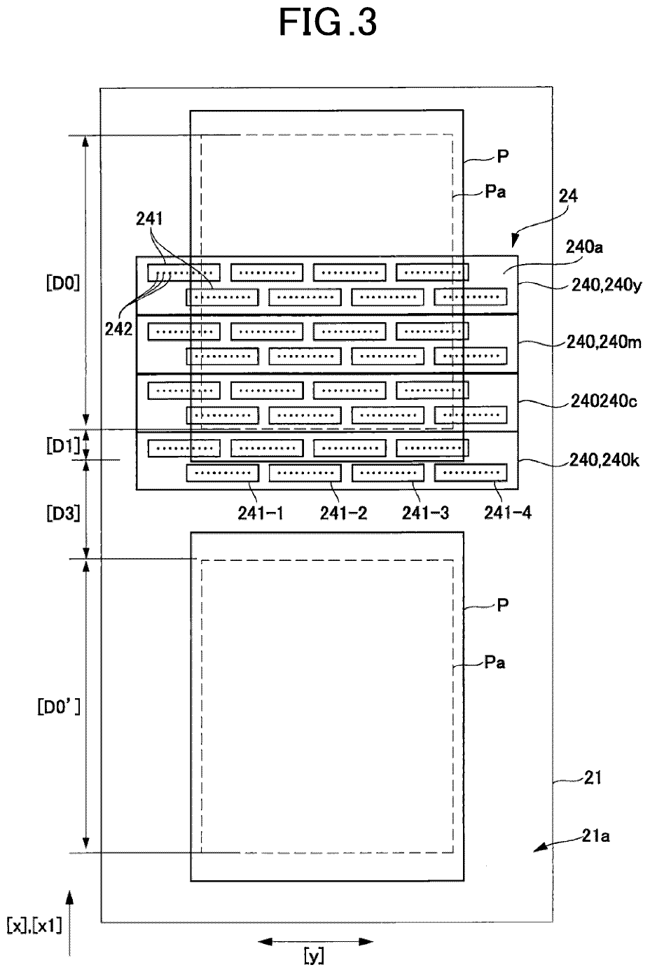

FIG. 3 is a diagram for illustrating a configuration of the ink ejecting device 24 included in the image forming apparatus according to the first embodiment, and is a diagram in which the conveyance surface 21a of the medium conveyance device 21 is viewed through the ink ejection face 240a of each head unit 240. In FIG. 3, in order to simplify the description, the ink heads 241 each in which the nozzles 242 are arranged in a row is illustrated in each head unit 240.

As illustrated in FIG. 3, the ink ejecting device 24 has a configuration in which a head unit 240y for yellow (Y), a head unit 240m for magenta (M), a head unit 240c for cyan (C), and a head unit 240k for black (K) are arranged in this order from the downstream side in the conveyance direction [x] of the recording medium P. Each head unit 240 is arranged over a conveyance width direction [y] perpendicular to the conveyance direction [x] of the recording medium P, and ejects ink over the conveyance width direction [y] of the recording medium P. Each head unit 240 ejects ink onto the recording medium P held on the conveyance surface 21a of the medium conveyance device 21 at an appropriate timing according to the rotation of the medium conveyance device 21.

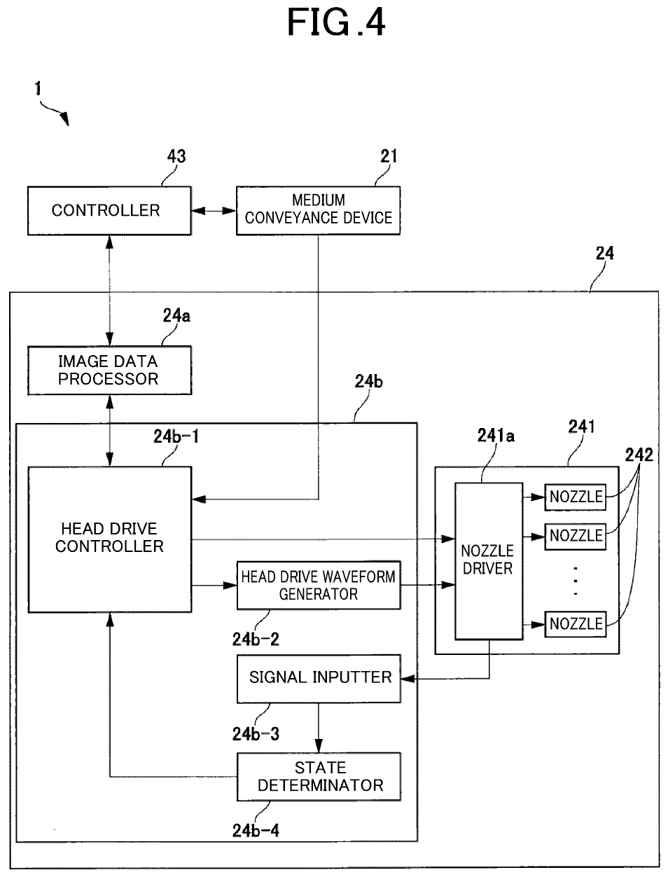

FIG. 4 is a block diagram of essential parts of the image forming apparatus 1 according to the first embodiment. As illustrated in FIG. 4, the ink ejecting device 24 includes an image data processor 24a and a head drive processor 24b as functional elements for controlling driving of the nozzles 242 of each ink head 241. The image data processor 24a and the head drive processor 24b each serve as a computing device, and function as an ink ejection inspecting device that determines the state of ink ejection from each nozzle 242 of each ink head 241. The computing device is hardware used as a so-called computer. The computing device includes a central processing unit (CPU) and memories such as a read only memory (ROM) and a random access memory (RAM).

Of these, the image data processor 24a buffers image data transmitted from a controller 43 described later and converts the image data into head ejection data.

In addition, the head drive processor 24b processes the driving and reverberant vibration of the head. Such a head drive processor 24b includes a head drive controller 24b-1, a head drive waveform generator 24b-2, a signal inputter 24b-3, and a state determinator 24b-4.

On the basis of the image date transmitted from the image data processor 24b, the date from the state determinator 24b-4, and a timing signal for image formation transmitted from the medium conveyance device 21, the head drive controller 24b-1 transmits nozzle ejection date and a drive control signal to a nozzle driver 241a of each ink head 241.

The head drive waveform generator 24b-2 generates a drive waveform for each nozzle 242 provided in each ink head 241 on the basis of the signal from the head drive controller 24b-1.

The signal inputter 24b-3 acquires, from the nozzle driver 241a of each ink head 241, a signal (vibration waveform) obtained by converting the vibration of each nozzle 242 into a voltage. In the vibration waveform, a waveform of residual vibration generated in the nozzle 242 appears immediately after the pulse wave is applied to the nozzle 242. The waveform of such residual vibration varies depending on the ejection state of the ink from the nozzle. Therefore, on the basis of the waveform of the residual vibration acquired by the signal inputter 24b-3, it can be determined whether the ink ejection state is normal.

The state determinator 24b-4 determines the state of each nozzle on the basis of the vibration waveform input to the signal inputter 24b-3. The state of the nozzle determined by the state determinator 24b-4 is whether the ink ejection state is normal. In addition, the state determinator 24b-4 determines whether the nozzle is in a state in which the ink ejection inspection is allowed to be performed or in a period during which the ink ejection inspection is waited to be performed. In addition, the state determinator 24b-4 transmits a determination result to the head drive controller 24b-1.

The procedures of the control and the determination implemented in the image data processor 24a and the head drive processor 24b as described above is a program stored in advance in the ROM, or a stored program loaded and stored in the RAM or the non-volatile storage from an external device. This control program causes the computing device to perform the steps described in the control method of the image forming apparatus described later.

### [Curing Light Emitting Device 25]

Returning to FIG. 1, the curing light emitting device 25 is provided on the downstream side of the ink ejecting device 24 in the conveyance direction [x] of the recording medium P and the rotation direction [x1] of the medium conveyance device 21. The curing light emitting device 25 emits energy rays such as ultraviolet rays to the recording medium P held on the conveyance surface 21a of the medium conveyance device 21, and cures and fixes the ink ejected onto the recording medium P.

### [Image Reading Device 26]

The image reading device 26 is provided on the downstream side of the curing light emitting device 25 in the conveyance direction [x] of the recording medium P, and reads the image formed on the surface of the recording medium P.

### [Deliverer 27]

The deliverer 27 is provided between the medium conveyance device 21 and the medium ejector 30, on the downstream side of the image reading device 26 and on the upstream side of the handover unit 22 in the conveyance direction [x] of the recording medium P. The deliverer 27 holds and picks up one end of the recording medium P being conveyed on the conveyance surface 21a of the medium conveyance device 21, and sends the recording medium P onto the sheet ejection tray 31 of the medium ejector 30.

### <Medium Ejector 30>

The medium ejector 30 includes the plate-like sheet ejection tray 31 on which the recording medium P ejected from the image former 20 is placed, and stores the recording medium P after image formation.

### <Control Device 40>

The control device 40 controls the driving of each member constituting the medium supplier 10, the image former 20, and the medium ejector 30. The control device 40 includes an operation part 41, a display 42, and the controller 43, and is connected to each of the medium supplier 10, the image former 20, and the medium ejector 30.

### [Operation Part 41]

The operation part 41 is used to enter various settings related to the image formation to be performed using the image forming apparatus 1. Furthermore, the operation part 41 may be an external device such as a personal computer or printer controller, which can make communication for reception and transmission of data with the controller 43 to be described later.

### [Display 42]

The display 42 displays the content of the operation on the operation part 41, the content set according to the operation on the operation part 41, and furthermore, other displays according to the next instruction of the controller 43. The display 42 is a notifier that provides a notification according to an instruction from the controller 43.

### [Controller 43]

The controller 43 controls the processing of image data input from an external device and the operation of each driving portion of the image forming apparatus 1 on the basis of the operation on the operation part 41. Such a controller 43 serves as a computing device.

The controller 43 forms an image on the recording medium P by controlling the driving of each component included in the medium supplier 10, the image former 20, and the medium ejector 30. The procedures of such control implemented by the controller 43 includes, as a control program for controlling the operation of each component of the image forming apparatus 1, a program stored in advance in the ROM, or a program loaded and stored in the RAM or the non-volatile storage from the external device. This control program causes the computing device to perform the steps described in the control method of the image forming apparatus described later.

The procedures of the control by the controller 43 having the above-described functional parts will be described in detail in the following ink ejection inspecting method.

### <<Ink Ejection Inspecting Method>>

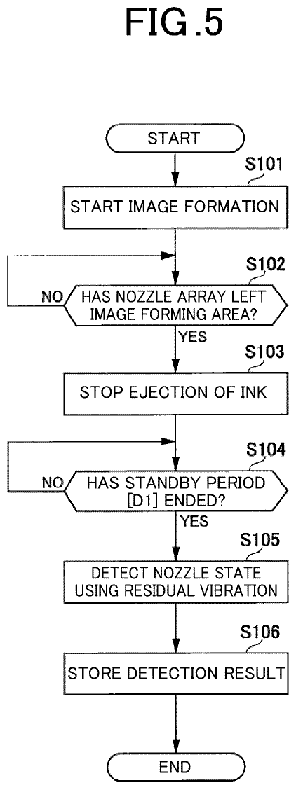

Next, an ink ejection inspecting method according to an embodiment will be described. FIG. 5 is a flowchart illustrating an ink ejection inspecting method according to the first embodiment, and illustrates procedures implemented by the image data processor 24a and the head drive processor 24b (see FIG. 4) each functioning as the ink ejection inspecting device described above executing an ink ejection inspecting program. Hereinafter, the ink ejection inspecting method according to the embodiment will be described with reference to FIGS. 1 to 4 and other drawings in the order illustrated in the flowchart of FIG. 5.

### <Step S101>

In Step S101, the head drive controller 24b-1 starts image formation on the recording medium P by ink ejection from each nozzle 242 according to an instruction from the controller 43. At this time, the head drive controller 24b-1 detects, on the basis of the timing signal for image formation transmitted from the medium conveyance device 21, that the nozzle arrays in each head unit 240 have reached an image forming area Pa of the recording medium P, and thus starts ink ejection from the nozzles 242 arranged in each nozzle array. Here, as illustrated in FIG. 3, the nozzle arrays refer to arrays of the nozzles 242 for one row arranged in the conveyance width direction [y].

### <Step S102>

In the next Step S102, the head drive controller 24b-1 determines whether the nozzle arrays for which image formation has been started in Step S101 have left the image forming area Pa. This determination is a determination as to whether each nozzle 242 in the nozzle arrays is in a image forming period [DO] (see FIG. 3), that is, whether the image forming period has ended. The head drive controller 24b-1 makes this determination on the basis of the timing signal from the medium conveyance device 21 and the information from the image data processor 24a. If the head drive controller 24b-1 determines that the nozzle arrays have left the image forming area Pa (YES), the process proceeds to the next Step S103.

### <Step S103>

In Step S103, the head drive controller 24b-1 stops the ejection of ink from each nozzle 242 in the nozzle arrays for which the image formation has been started in Step S101.

### <Step S104>

In Step S104, the state determinator 24b-4 determines whether a standby period [D1] has ended for each nozzle 242 in the nozzle arrays for which the ejection of ink was stopped in Step S103, on the basis of the vibration waveform input to the signal inputter D1-3. Here, the standby period [D1] is a period during which application of an inspection voltage to each of the nozzles 242 for ink ejection inspection is waited after image formation is completed. The standby period [D1] is a period until the effect of the application of the drive voltage to the nozzles 242 for image formation on each of the nozzles 242 is eliminated. Here, the standby period [D1] is a period until the residual vibration generated in the nozzle due to the application of the drive voltage to the nozzles 242 for the image formation becomes stable.

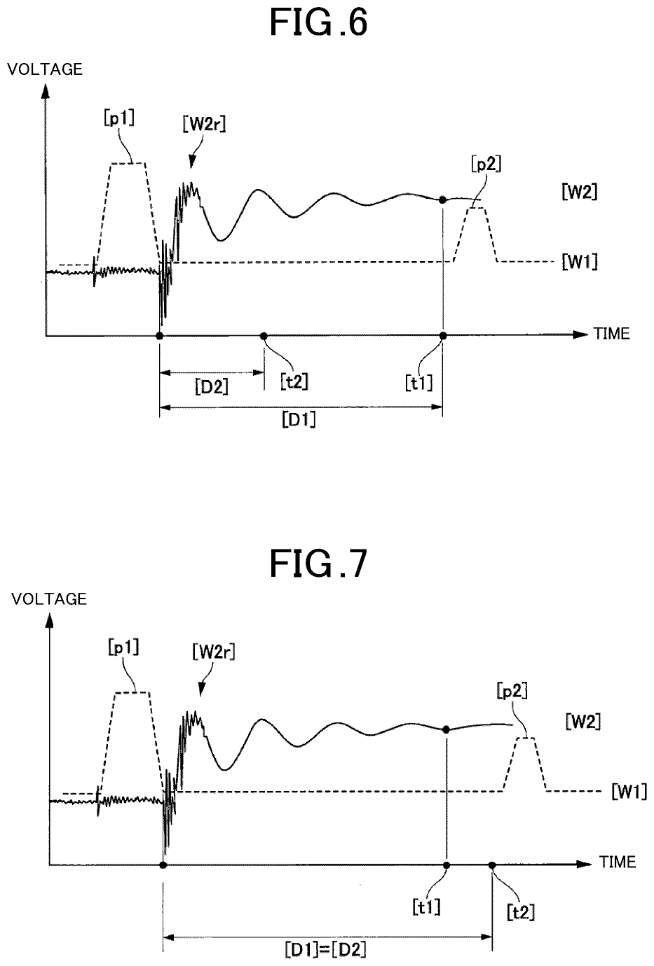

FIG. 6 is a diagram (No. 1) illustrating the standby period of the ink ejection inspecting method according to the first embodiment, and is a diagram illustrating a drive signal waveform [W1] to be applied to the nozzle and a vibration waveform [W2] obtained by converting vibration generated in the nozzle into a voltage to output the voltage. As illustrated in FIG. 6, when a pulse wave [p1] for image formation is applied to the nozzle as the drive signal waveform [W1], residual vibration [W2r] due to the vibration of the nozzle appears in the vibration waveform [W2] immediately thereafter.

After stopping the ejection of ink in Step S103, the state determinator 24b-4 determines that the standby period [D1] has ended (YES) at a convergence time point [t1] when the amount of change in the vibration waveform [W2] input to the signal inputter D1-3 falls within a predetermined range. The amount of change in this case is, for example, the magnitude of the amplitude of the vibration waveform [W2], and is set to a range that does not affect the ink ejection inspection to be performed next.

Here, the standby period [D1] includes a switching period [D2] required for processing a signal for switching a drive signal for image formation to an inspection signal for ink ejection inspection. Therefore, when the end time point [t2] of the switching period [D2] is earlier than the convergence time point [t1], the standby period [D1] may be set to a period until the convergence time point [t1].

FIG. 7 is a diagram (No. 2) illustrating the standby period [D1] of the ink ejection inspecting method according to the first embodiment. As illustrated in FIG. 7, when the end time point [t2] of the switching period [D2] is later than the convergence time point [t1], the standby period [D1] may be set to a period until the end time point [t2] of the switching period [D2].

Similarly to the switching period [D2], the standby period [D1] includes the minimum ink ejection interval from each nozzle.

As described above, if the state determinator 24b-4 determines that the standby period [D1] has ended (YES), the process proceeds to the next Step S105.

### <Step S105>

In Step S105, the head drive controller 24b-1 performs the nozzle state detection using the residual vibration with respect to each nozzle 242 of the nozzle arrays for which it is determined in Step S104 that the standby period [D1] has ended. At this time, in response to an instruction from the head drive controller 24b-1, the nozzle driver 241a applies an inspection voltage for ink ejection inspection to each of the nozzles 242 as a pulse wave [p2]. The voltage value of this pulse [p2] is a magnitude set in advance, and may be a magnitude that causes ink to be ejected, or may be a magnitude that does not cause ink to be ejected.

Accordingly, the state determinator 24b-4 determines the ejection state of the ink of each nozzle 242 on the basis of the residual waveform input to the signal inputter 24b-3. The determination of the ink ejection state by the state determinator 24b-4 is performed by, for example, comparing a normal waveform obtained from a normal nozzle in which the ink ejection state is normal with the residual waveform obtained here. The comparison of the waveforms is, for example, comparison of feature values such as amplitude, period, bias level (average bias), attenuation rate, and phase of the waveforms.

Note that the head drive controller 24b-1 may select only the nozzles 242 used for image formation from among the nozzles 242 in the nozzle arrays for which it has been determined in Step S104 that the standby period [D1] has ended, and perform nozzle state detection using residual vibration. For example, as illustrated in FIG. 3, the nozzles 242 positioned outside the image forming area Pa of the recording medium P in the conveyance width direction [y] do not eject ink during image formation. Therefore, these nozzles 242 may be configured not to perform the nozzle state detection using residual vibration.

Furthermore, as illustrated in FIG. 3, the head drive controller 24b-1 performs the nozzle state detection in an inspection period [D3] until the next imaging forming area Pa reaches the nozzle arrays after the end of the standby period [D1]. That is, the nozzle state detection is performed in a case where each nozzle 242 in the nozzle arrays is in the non-image forming period between the image forming period [DO] and the next image forming period [DO′]. These nozzle arrays are nozzle arrays for which it has been determined in Step S104 that the standby period [D1] has ended.

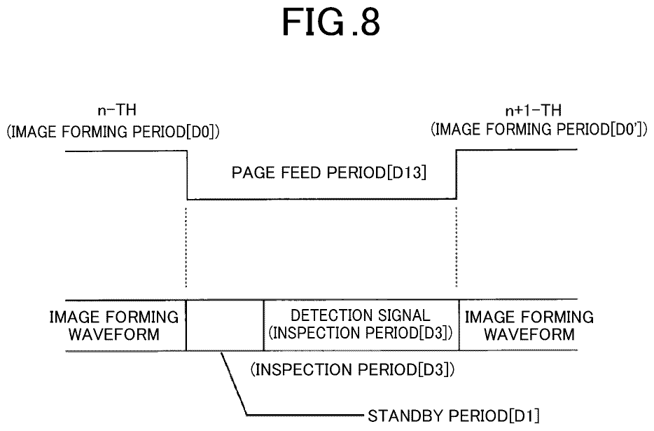

FIG. 8 is a diagram illustrating image formation including the ink ejection inspecting method according to the embodiment. As illustrated in FIG. 8, a period between the image forming period [DO] for the N-th recording medium and the image forming period [DO′] for the next (n+1)-th recording medium is a page feed period [D13] (non-image forming period). At the beginning of the page feed period [D13], the above-described standby period [D1] is set. The remaining period of the page feed period [D13] after the end of the standby period [DO] is the inspection period [D3]. In the inspection period [D3], the head drive controller 24b-1 (see FIG. 4) performs the nozzle state detection using residual vibration on each of the nozzles 242 in the nozzle arrays for which it is determined in Step S104 that the standby period [D1] has ended.

### <Step S106>

In Step S106, the head drive controller 24b-1 stores the detection result of the nozzle state detection in Step S105 for each nozzle 242, and ends the process.

Note that the head drive controller 24b-1 may cause the display 42 of the control device 40 to display a result of the detection, and may perform automatic maintenance on a nozzle for which an ink ejection failure has been recognized. Furthermore, the head drive controller 24b-1 may be configured to form an image in the subsequent image forming area Pa by complementing the ink ejection from the nozzle in which the ink ejection failure is recognized with the ink ejection from other nozzles.

### Effect of First Embodiment

As described above, the first embodiment has a configuration in which the ink ejection inspection is performed after the standby period [D2] for converging the residual vibration [W2r] caused by the application of the drive voltage for image formation has elapsed. Thus, the residual vibration [W2r] caused by the application of the drive voltage for image formation does not affect the residual vibration of the nozzles caused by the application of the drive voltage for ink ejection inspection. As a result, the ink ejection state of each nozzle can be accurately detected, and a high-definition image can be formed by highly accurate ink ejection on the basis of the detection result.

### Second Embodiment

### <<Image Forming Apparatus>>

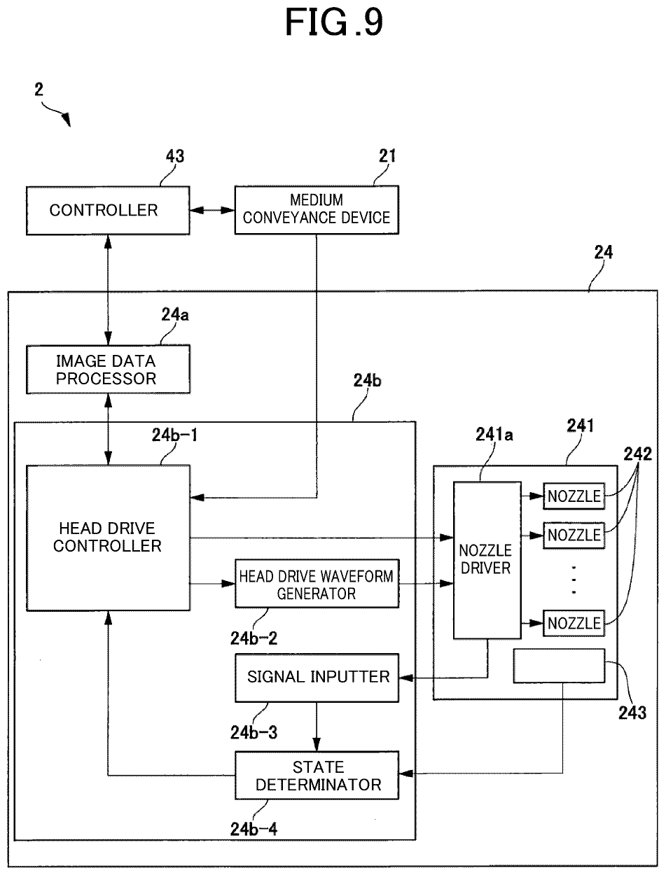

FIG. 9 is a block diagram of essential parts of an image forming apparatus 2 according to a second embodiment. The image forming apparatus 2 illustrated in FIG. 9 is different from the image forming apparatus according to the first embodiment in that each ink head 241 includes a temperature sensor 243 and a head drive controller 24b-1 functioning as an ink ejection inspecting device makes a determination based on information from the temperature sensor 243. The other configuration is the same as that of the image forming apparatus of the first embodiment, and therefore, repetitive descriptions thereof will be omitted.

### <<Ink Ejection Inspecting Method>>

The ink ejection inspecting method of the second embodiment is different from the ink ejection inspecting method of the first embodiment described with reference to the flowchart of FIG. 5 in the procedure of determining whether the standby period [D1] of Step S104 has ended, and the other steps are the same. Therefore, the procedure of Step S104 illustrated in FIG. 5 will be described with reference to FIG. 9 and other necessary drawings.

### <Step S104>

In Step S104, the state determinator 24b-4 determines, for each of the nozzles 242 in the nozzle arrays that have stopped ejecting ink in Step S103, whether the standby period [D1] has ended, on the basis of the temperature of the ink head 241 acquired from the temperature sensor 243. Here, the standby period [D1] is a period during which application of a drive signal for ink ejection inspection to the nozzles 242 is stopped after image formation is completed. Here, the standby period [D1] is a period until the temperature of each ink head 241 reaches a predetermined temperature range.

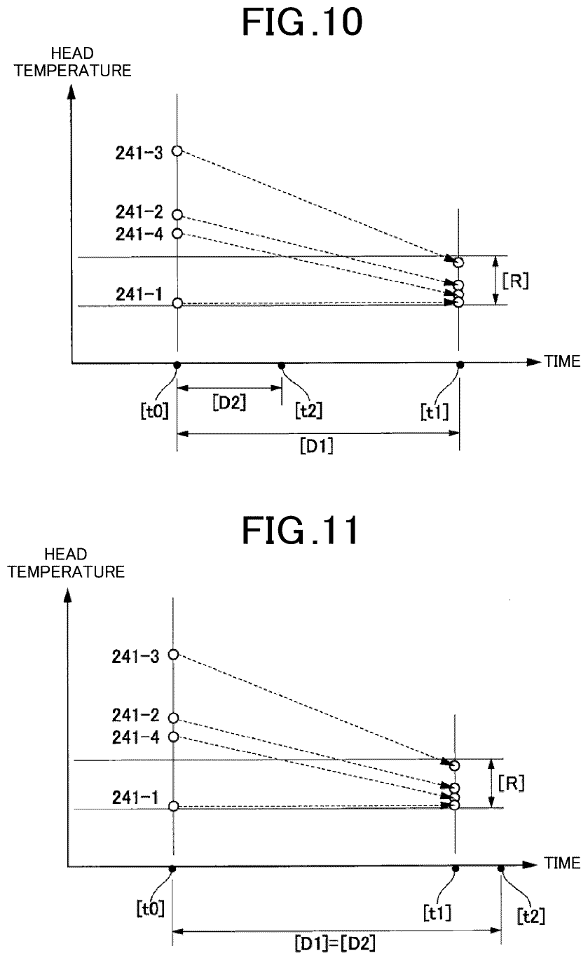

FIG. 10 is a diagram (No. 1) illustrating the standby period [D1] of the ink ejection inspecting method according to the second embodiment, and is a diagram illustrating the elapsed time of the temperature of each ink head 241. As illustrated in FIG. 10, the temperature of each of the ink heads 241-1 to 242-4 decreases with the elapse of time from the ejection stop time point [t0] at which the ink ejection from the nozzles 242 for image formation is stopped. The ink heads 241-1 to 242-4 are arranged in the conveyance width direction [y].

The state determinator 24b-4 determines that the standby period [D1] has ended (YES) at a convergence time point [t1] at which the temperatures of the ink heads 242-1 to 241-4 detected by the temperature sensors 243 fall within the predetermined temperature range [R] after the ejection of ink is stopped in Step S103. It is assumed that this temperature range [R] is set as a range that does not affect the ink ejection inspection by a preliminary experiment. In addition, this temperature range may be a range of the magnitude of variation in the temperature of each of the ink heads 241-1 to 242-4, and even in this case, it is assumed that the temperature range is set by an experiment in advance.

Here, similarly to the first embodiment, the standby period [D1] includes the switching period [D2] required for the signal process for switching the drive signal for the image formation to the drive signal for the ink ejection inspection. Therefore, when the end time point [t2] of the switching period [D2] is earlier than the convergence time point [t1], the standby period [D1] may be set to a period until the convergence time point [t1].

FIG. 11 is a diagram (No. 2) illustrating the standby period [D1] of the ink ejection inspecting method according to the second embodiment. As illustrated in FIG. 11, when the end time [t2] of the switching period [D2] is later than the convergence time [t1], the standby period [D1] may be set to the end time [t2] of the switching period [D2], as in the first embodiment.

Furthermore, similarly to the switching period [D2], the standby period [D1] includes the minimum ink ejection interval from each nozzle, as in the first embodiment.

As described above, if the state determinator 24b-4 determines that the standby period [D1] has ended (YES), the process proceeds to the next Step S105.

Note that the determination in Step S104 is made for the nozzle arrays for which ink ejection has been stopped in Step S103. That is, for each of these nozzle arrays, the state determinator 24b-4 determines the end of the standby period [D1] on the basis of the temperature of each of the ink heads 241-1 to 242-4 provided with the respective nozzle arrays.

### Effect of Second Embodiment

As described above, the second embodiment has a configuration in which the ink ejection inspection is performed after the standby period [D1] for converging the temperature change of the ink head caused by the application of the drive voltage for the image formation has elapsed. Thus, the temperature change of the ink head 241 caused by the application of the drive voltage for the image formation does not affect the residual vibration of the nozzles caused by the application of the drive voltage for the ink ejection inspection. As a result, similarly to the first embodiment, it is possible to accurately detect the ink ejection state of each nozzle, and it is possible to form a high-definition image by highly accurate ink ejection.

Note that the second embodiment can be combined with the first embodiment. In this case, when the residual vibration [W2r] caused by the application of the drive voltage for image formation has converged and the temperature change of the ink head has converged in Step S104, the state determinator 24b-4 may determine that the standby period [D1] has ended (YES). Accordingly, it is possible to more accurately detect the ink ejection state of each nozzle.

According to the present invention, it is possible to provide an ink ejection inspecting device, an ink ejection inspecting method, and an ink ejection inspecting program capable of accurately detecting an ink ejection state of each nozzle, and further to provide an ink ejecting device and an image forming apparatus capable of forming an image by ink ejection controlled with high accuracy.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-192804, filed on Nov. 13, 2023, including description, claims, drawings and abstract is incorporated herein by reference.

What is claimed is:

1. An ink ejection inspecting device that inspects an ejection state of inks from a plurality of nozzles provided in an ink ejecting device, the ink ejection inspecting device comprising:
a hardware processor,
wherein the hardware processor applies an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges; and
determines an ink ejection state of each of the nozzles on a basis of residual vibration of each of the nozzles obtained by applying the inspection voltage.

2. The ink ejection inspecting device according to claim 1, wherein
the hardware processor
determines whether the standby period has ended for each of the nozzles on the basis of the residual vibration of each of the nozzles obtained by applying the drive voltage, and
applies the inspection voltage to a nozzle for which it is determined that the standby period has ended among the nozzles.

3. The ink ejection inspecting device according to claim 2, wherein
the hardware processor determines that the standby period has ended when an amplitude of the residual vibration of each of the nozzles obtained by applying the drive voltage falls within a predetermined range.

4. The ink ejection inspecting device according to claim 1, wherein
the hardware processor
determines whether the standby period has ended for each of the nozzles on the basis of a temperature of an ink head provided with the plurality of nozzles; and
applies the inspection voltage to a nozzle for which it is determined that the standby period has ended among the nozzles.

5. The ink ejection inspecting device according to claim 4, wherein
the hardware processor determines that the standby period has ended when the temperature of the ink head falls within a predetermined range.

6. The ink ejection inspecting device according to claim 4, wherein
the hardware processor determines that the standby period has ended when a variation in the temperature of a plurality of the ink heads at which the image forming periods end substantially at the same time falls within a predetermined range.

7. The ink ejection inspecting device according to claim 1, wherein
the standby period includes a minimum ink ejection interval from each of the nozzles.

8. The ink ejection inspecting device according to claim 1, wherein
the hardware processor
in a non-image forming period between the image forming period and a next image forming period, applies an inspection voltage for an ink ejection inspection to each of the nozzles.

9. The ink ejection inspecting device according to claim 1, wherein
the standby period includes a switching period required for a switching process from an output waveform of the drive voltage to an output waveform of the inspection voltage.

10. The ink ejection inspecting device according to claim 1, wherein
the hardware processor applies the inspection voltage to a nozzle selected from among the plurality of nozzles.

11. The ink ejection inspecting device according to claim 1, wherein
the hardware processor
applies the inspection voltage to the nozzles in order from a nozzle for which the standby period has ended among the plurality of nozzles.

12. The ink ejection inspecting device according to claim 1, wherein
the ink ejecting device includes a plurality of nozzle arrays in which a plurality of nozzles are arranged, and
the hardware processor
determines the end of the standby period and applies the inspection voltage in order from the nozzles in a nozzle array for which the standby period has ended among the plurality of nozzle arrays.

13. An ink ejection inspecting method that inspects an ejection state of inks from a plurality of nozzles provided in an ink ejecting device, wherein
the hardware processor applies an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges, and
the hardware processor determines an ink ejection state of each of the nozzles on a basis of residual vibration of each of the nozzles obtained by applying the inspection voltage.

14. A storage medium storing an ink ejection inspecting program causing a computer to perform an inspection of an ejection state of inks from a plurality of nozzles provided in an ink ejecting device, the inspection comprising:
applying an inspection voltage for an ink ejection inspection to each of the nozzles after a standby period ends, the standby period being from after an image forming period during which a drive voltage for image formation is applied to each of the nozzles ends until an effect of the application of the drive voltage to each of the nozzles converges; and
determining an ink ejection state of each of the nozzles on a basis of residual vibration of each of the nozzles obtained by applying the inspection voltage.

15. An ink ejecting device, comprising:
an ink head provided with a plurality of nozzles that eject an ink by application of a voltage; and
the ink ejection inspecting device according to claim 1.

16. The ink ejecting device according to claim 15, wherein
the ink head has a configuration in which the plurality of nozzles are arranged in at least one direction.

17. The ink ejecting device according to claim 16, further comprising:
a head unit in which a plurality of the ink heads are arranged in the one direction.

18. An image forming apparatus, comprising:
the ink ejecting device according to claim 15; and
a medium conveyance device that conveys a recording medium on which an image is formed with inks ejected from the plurality of nozzles in the ink ejecting device in a predetermined conveyance direction relative to the ink ejecting device.

19. The image forming apparatus according to claim 18, wherein
the plurality of nozzles in the ink ejecting device are arranged over a conveyance width direction perpendicular to a conveyance direction of the recording medium.

20. The image forming apparatus according to claim 19, wherein
a plurality of nozzle arrays in which the plurality of nozzles are arranged in the conveyance width direction are arranged in the conveyance direction.
